(19) United States
(12) Patent Application Publication
(10) Pub. No.: US 2009/0315738 A1
(43) Pub. Date: Dec. 24, 2009

(54) Location of a Motor Vehicle in a Car Park

(76) Inventors: Rainer Falk, Erding (DE); Alla Heidenreich, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/522,359

(22) PCT Filed: Dec. 28, 2007
(86) PCT No.: PCT/EP2007/064624

§ 371 Date: Jul. 7, 2009

(30) Foreign Application Priority Data
Jan. 16, 2007 (DE) 10 2007 002 198.6

(51) Int. Cl. B60Q 1/48

(52) U.S. Cl. 340/932.2

(57) ABSTRACT

A method for location of a motor vehicle in a parking lot is provided. The method permits recording and display of a parking space of a motor vehicle in a parking lot. A video image analysis is carried out so that the number plate of the motor vehicle can be allocated to the relevant parking space of the motor vehicle.

This application is the U.S. National Stage of International Application No. PCT/EP2007/064624 filed Dec. 28, 2007 and claims the benefit thereof. The International Application claims the benefits of German Patent Application No. 10 2007 002 198.6 DE filed Jan. 16, 2007; both of the applications are incorporated by reference herein in their entirety.

### FIELD OF INVENTION

The invention relates to establishing the location of a vehicle in a car parking lot.

### BACKGROUND OF INVENTION

In large facilities with a very large volume of vehicles, such as airports of sports stadia for example, parking lots are now provided with in some cases considerably more than 5000 parking spaces. For example high-rise parking lot T2 at the Franz-Josef-Strauss airport in Munich has 11 levels with over 6400 parking spaces and the high-rise parking lot in the Allianz Arena in Munich has over 10500 parking spaces spread over four levels.

In such huge parking facilities many visitors have problems finding where they have parked their vehicle. There is thus a need to identify the location of a vehicle parked in a parking lot such as an underground parking lot or a surface parking lot for example, as uniquely as possible, and thereby enable it to be found again.

Previously this problem has been solved by subdividing the parking lot into different spatial sections and identifying these sections by alphanumeric characters. Thus the parking space of a motor vehicle can be identified for example as level 4, section H, parking space 132. The disadvantage in this case is that the keeper of the vehicle can mislay the corresponding alphanumeric character sequence and subsequently has to search for the location of their vehicle.

### SUMMARY OF INVENTION

An object of the present invention is to specify a method with which a vehicle keeper can determine the location of their vehicle in a parking lot without having to note additional location information to do so.

This object is achieved by a method as claimed in the independent claim. Advantageous developments of the invention are specified in the dependent claims.

In accordance with the present invention, in a method for determining the location of a motor vehicle in a parking lot, the vehicle is identified by means of an automatic number plate recognition system as it drives into the parking lot. The parking space of the motor vehicle identified on the basis of number plate recognition is established by means of video image-based object tracking. Subsequently the number plate and the parking space of the motor-vehicle are assigned to identification information and stored. On request, by entering at least one part of the identification information, a position of the parking space is displayed. In this way it is a simple matter for the keeper of the motor vehicle to establish the location of their motor vehicle and have it displayed. To this end the motor vehicle keeper can for example request the location by entering their number plate on an interrogation device provided for the purpose or by passing on this information to one of the service personnel. In accordance with a further variant the parking space determined is displayed or printed out to the motor vehicle keeper when they pay for their parking ticket. It is also especially advantageous for a video surveillance system installed in any event in the parking lot to be able to be used for video image-based object tracking in order to enable such a convenient service to be offered for finding parked vehicles.

In accordance with a further advantageous embodiment of the invention a parking ticket is identified by parking ticket information. The parking ticket information is additionally assigned to identification information and stored. This advantageously makes it possible for a motor vehicle keeper to only require the parking ticket to identify their motor vehicle.

In accordance with the further advantageous embodiment of the invention, a route between the position of the parking space of the motor vehicle and a predetermined position of a user is established. Subsequently a description of the route to the vehicle is displayed. The predeterminable position of the user is for example the position of the interrogation device or of the automatic parking ticket dispenser. This has the further advantage that the keeper of the motor vehicle does not need to orient themselves further in the parking lot but only needs to follow the description of the route the parking space of their motor vehicle.

In accordance with a further embodiment the position of the parking space of the motor vehicle is displayed by the parking space being illuminated in a predetermined fashion using lighting. There is thus provision for example that, after the parking ticket has been paid for, the corresponding motor vehicle is identified by a brighter lighting or by different-colored lighting. In this way the motor vehicle keeper can find their vehicle more easily. Furthermore the motor vehicle can be made visible by a specific lighting code, such as red-blue flashing for example. When the parking ticket is paid for this specific lighting code is notified to the motor vehicle keeper.

### BRIEF DESCRIPTION OF THE DRAWINGS

The present invention will be explained below in greater detail on the basis of an exemplary embodiment which refers to the drawing.

The FIGURE shows:

FIG. 1 a diagram of the possible arrangement for using the inventive method for establishing a location for a motor vehicle.

### DETAILED DESCRIPTION OF INVENTION

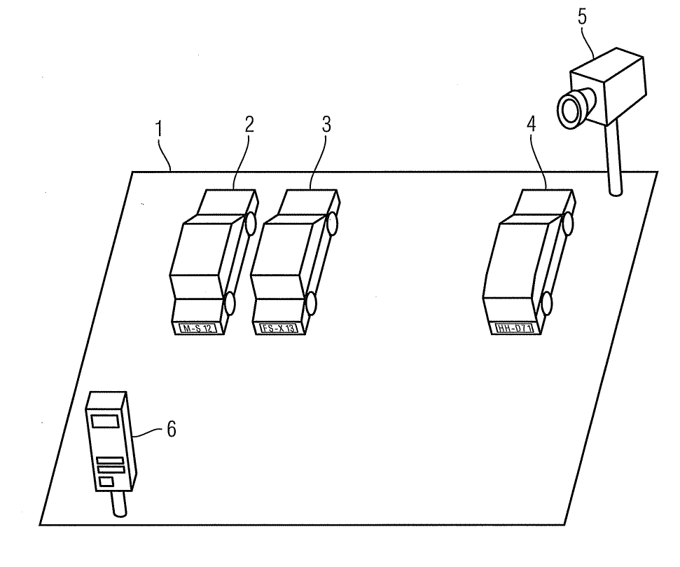

FIG. 1 shows the parking lot 1 with three motor vehicles 2, 3, 4 parked on it. Video images of the entire parking lot 1 are recorded by at least one video camera 5. FIG. 1 also shows an automatic parking ticket dispenser 6, which on the one hand is used to pay for the parking tickets and on the other hand is used to request the location of a motor vehicle.

If a motor vehicle now drives into the parking lot 1, automatic number plate recognition is first undertaken with the aid of a video camera 5.

For automatic number plate recognition a series of algorithm steps are usually applied to the recorded video image. First the position of the number plate is recognized in the video image. Subsequently, in an image pre-processing step, differences in the spatial position and in the size of the number plate are compensated for. The brightness and contrast of the image are also optimized. Subsequently the individual characters of the number plate are identified in a segmentation and assigned to different areas. Finally, by feature extraction methods, the individual characters are assigned features and allocated by a classification to individual alphanumeric characters.

While the motor vehicle 2 is being maneuvered into its final parking space in the parking lot 1, video images of the motor vehicle 2 continue to be recorded, on the basis of which the motor vehicle 2 is tracked into its final parking space.

Alternatively it is also possible to record video images of parking spaces in the parking lot and to apply a predetermined rule in accordance with the number plate recognition of motor vehicles to the parking spaces recorded. The number plates recognized and the corresponding parking spaces in the parking lot are assigned to each other in a database.

Finally both the number plate and the parking space of the motor-vehicle determined are assigned to identification information and stored.

The motor vehicle keeper now has different options for calling to mind the parking space of their motor vehicle. They can thus enter the character sequence of their number plate at an interrogation device provided for this purpose, whereupon the parking space of their motor vehicle is displayed to them. This is typically done by the parking space being displayed in a descriptive and/or illustrative form on a display of the interrogation device or by the corresponding information being printed out by the interrogation device. It is also possible for the motor vehicle keeper to contact one of the service personnel and receive the desired information from them.

A further option for obtaining information about the parking space of the motor vehicle is for the motor vehicle keeper to have the desired information displayed to them and/or printed out for them when they pay for the parking ticket. In this way the requested motor vehicle is identified via the parking ticket. The assignment of the parking ticket to the motor vehicle is undertaken in this case when the vehicle drives into the parking lot and by the associated automatic number plate recognition.

In a further exemplary embodiment the position of the motor vehicle parking space is indicated by lighting. It is thus possible for example for the parking space of the motor vehicle to be made visible by brighter lighting or by a particular color of lighting. It is further possible to provide information on the parking space by a specific lighting pattern, such as red-green flashing for example. The motor vehicle keeper can be alerted to the specific form of lighting again by corresponding information which is displayed and/or printed out.

1.-6. (canceled)

7. A method for location of a motor vehicle in a parking lot, comprising:
identifying the motor vehicle by automatic number plate recognition when the motor vehicle drives into the parking lot;
determining a parking space of the identified motor vehicle by video image-based object tracking;
assigning the number plate and the parking space of the motor vehicle to an identification information;
storing the identification information including the number plate and the parking space;
entering at least a part of the identification information; and
displaying a position of the parking space of the motor vehicle.

8. The method as claimed in claim 7, further comprising:
characterizing a parking ticket by parking ticket information;
assigning the parking ticket information to the identification information; and
storing the identification information including the number plate, the parking space and the parking ticket information.

9. The method as claimed in claim 7, further comprising:
establishing a route between the position of the parking space and a predeterminable position of a user; and
displaying a route description of the established route.

10. The method as claimed in claim 7, wherein the position of the parking space is displayed by illuminating the parking space by a lighting.

11. The method as claimed in claim 7, wherein the position of the parking space is displayed on a display in a descriptive and illustrative form.

12. The method as claimed in claim 7, wherein the position of the parking space is displayed on a display in a descriptive form.

13. The method as claimed in claim 7, wherein the position of the parking space is displayed on a display in an illustrative form.

14. The method as claimed in claim 7, wherein the entering of at least a part of the identification information comprises entering the number plate.

15. The method as claimed in claim 7, wherein the entering of at least a part of the identification information comprises entering the parking ticket.
